(19) United States
(12) Patent Application Publication
(10) Pub. No.: US 2009/0124941 A1
(43) Pub. Date: May 14, 2009

(54) MASSAGE APPARATUS AND COVER

(75) Inventor: Mordechai Lev, West Bloomfield, MI (US)

Correspondence Address: BROOKS KUSHMAN P.C., 1000 TOWN CENTER, TWENTY-SECOND FLOOR, SOUTHFIELD, MI, 48075, US

(73) Assignee: FKA DISTRIBUTING CO. D/B/A HOMEDICS, INC., Commerce Township, MI (US)

(21) Appl. No.: 12/258,829

(22) Filed: Oct. 27, 2008

Related U.S. Application Data
(60) Provisional application No. 60/982,609, filed on Oct. 25, 2007.

(51) Int. Cl. A61H 7/00; B32B 37/00; B32B 3/06

(52) U.S. Cl. 601/134; 156/299; 428/99

(57) ABSTRACT

A removable cover portion for a body massager is provided with a sheet of material sized to be placed upon the body massager and adapted to be fastened to the body massager. The sheet has a reduced contact area for altering a resultant massage effect. A method for Manufacturing the cover portion provides the sheet, integrally forms a massage formation with at least two massage nodes and a cross member interconnecting the at least two massage nodes, and assembles a plurality of massage formations to the sheet of material whereby the cross members maintain the orientation of the corresponding adjacent massage nodes during assembly of the massage nodes to the sheet of material.

### CROSS-REFERENCE TO RELATED APPLICATIONS

This application claims the benefit of U.S. provisional application Ser. No. 60/982,609 filed Oct. 25, 2007, which is incorporated in its entirety by reference herein.

### BACKGROUND

1. Field of the Invention

Embodiments of the invention relate to massage apparatuses with removable covers, and removable covers therefore.

2. Background Art

A portable body massager with a removable cover is illustrated and described in U.S. Pat. No. 7,128,721 B2, which issued to Ferber et al. on Oct. 31, 2006.

### BRIEF DESCRIPTION OF THE DRAWINGS

FIG. 1 is a perspective view of a body massage apparatus in accordance with an embodiment of the present invention;

FIG. 2 is a perspective view of the body massage apparatus of FIG. 1 illustrated with a cover attached thereto;

FIG. 3 is another perspective view of the body massager of FIG. 1, illustrated with another cover attached thereto and illustrated supported upon a chair;

FIG. 4 is a side perspective view of the body massage apparatus, cover, and chair of FIG. 3;

FIG. 5 is a perspective view of the cover of FIG. 3; and

FIG. 6 is an enlarged front elevation view of a region of the cover of FIG. 3.

### DETAILED DESCRIPTION OF EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

With reference to FIG. 1, a body massager is illustrated in accordance with an embodiment of the present invention and is referenced generally by numeral 10. The body massager 10 includes a backrest region 12 and a seat support region 14. The internal assemblies of the backrest region 12 and the seat support region 14 are collectively retained within a flexible cover 16, which is formed of a high quality vinyl. Of course, other materials such as leather may be employed for the cover 16. The cover 16 provides a pivotal connection 18 at a lower longitudinal end of the backrest region 12 and a rearmost end of the seat support region 14. The flexible material of the cover 16 provides a living hinge at the pivotal connection 18 permitting user adjustment of an included angle between the backrest region 12 and the seat support region 14. In at least one embodiment, the cover 16 includes a central woven fabric panel 20 along the backrest region 12.

Massage effects provided by the body massager 10 include a longitudinal percussive massage effect from a massage assembly 22. The massage assembly 22 provides a percussive or tapping motion through the central panel 20 for massaging the back of the user, as illustrated by the arrows directed towards and away from the backrest region 12. Additionally, the massage assembly 22 translates along the backrest region 12 for massaging various longitudinal regions of the user's back. Alternatively, a massage assembly 24 may be provided for imparting a kneading massage effect to the user. For example, the massage assembly 24 imparts a rotary kneading massage effect to the user, which may also translate along the backrest region 12. One such rotary kneading massager is disclosed in U.S. Pat. No. 7,128,721 B2, which issued on Oct. 31, 2006 to Ferber et al., which is incorporated in its entirety by reference herein. Another suitable rotary kneading massager is disclosed in U.S. Patent Application Publication 2006/0211962 A1, which published on Sep. 21, 2006 to Ferber et al. and is also incorporated in its entirety by reference herein. The backrest region 12 may include one massage assembly 22 or 24, or both massage assemblies 22, 24, or any other suitable massage assembly, such as a vibratory massage assembly, a rolling massage assembly, or the like. Additionally, the seat support region 14 may also provide a massage effect, such as a vibratory massage effect for the user seated thereupon.

The backrest region 12 is sized to be received upon a backrest of a conventional chair. Likewise, the seat support region 14 is sized to be received upon a seat support of a conventional chair. Additionally, the body massager 10 is portable due to its compact size and lightweight so that the user may place the body massager 10 upon a conventional chair for receiving a massage when seated upon the chair. The adjustability of the included angle between the backrest region 12 and the seat support region 14 accommodates a wide range of angles that may be incorporated in conventional chairs. Alternatively, the body massager 10 may rest flat upon a floor or may be supported by a floor and an adjoining wall.

The backrest region 12 includes a height and width corresponding to the conventional chair and has a thickness that is adequate for housing the massage assembly 22, 24 therein while avoiding disruption of comfort and support provided by the underlying chair. Likewise, the seat support region 14 has a width and a depth corresponding to that of the conventional seat support and has a thickness that is adequate for housing the associated massage assembly while avoiding disruption of comfort and support provided by the underlying chair.

The seat support region 14 includes a seating surface 26 provided thereon for receiving the user when seated. The backrest region 12 includes a backrest surface 28 for receiving and supporting the back of the user thereupon. The massage assemblies 22, 24 of the backrest region 12 and the seat support region 14 impart the respective massage effects through the backrest surface 28 and the seating surface 26, respectively.

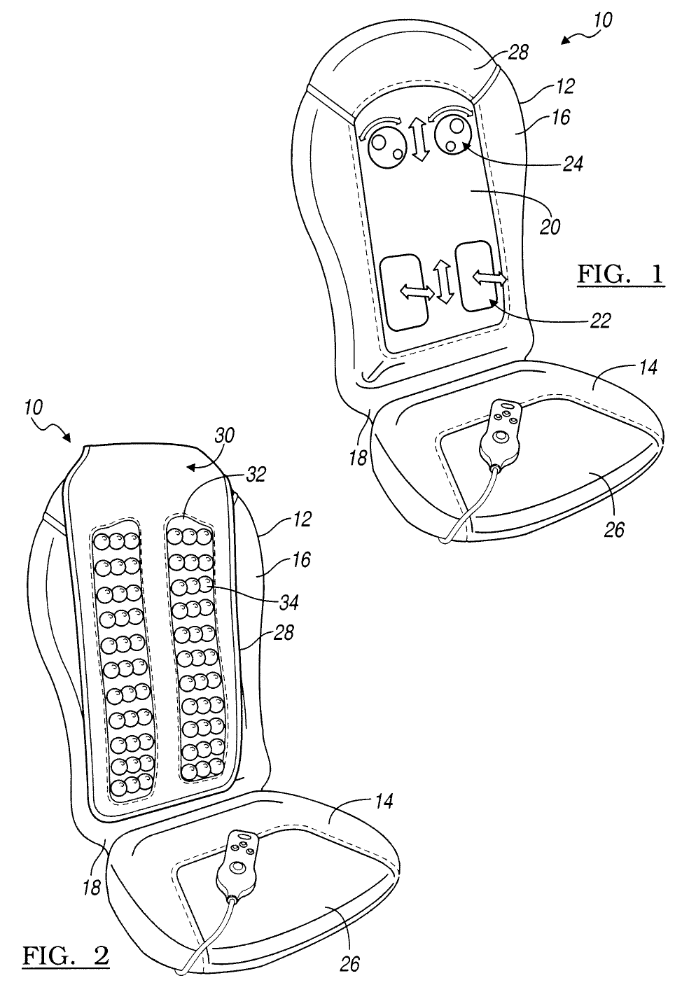

Referring now to FIG. 2, the cover 16 may be provided with an additional cover portion, such as a removable flap 30 that is mounted to the backrest region 12 along the backrest surface 28. The flap 30 is removably attached by a hook and loop material so that the user may remove the flap 30 and expose the woven fabric central panel 20. In at least one embodiment, the flap 30 includes two arrays 32 of massage nodes 34. Each array 32 is spaced laterally apart from center to focus on either side of a back region spaced apart from the user's spine. The flap 30 permits the user to attach or remove the flap 30 for altering the resultant massage effects. For example, the massage nodes 34 and the arrays 32 provide a series of contacts with the user that reduce the area in comparison to the massage assembly 22. Thus, instead of receiving a surface contact associated with the massage assembly 22, the user receives a plurality of reduced surface contacts thereby increasing the pressure applied at each contact point upon the user, resulting in a more aggressive and targeted massage action. Alternatively, if the massage assembly 22 includes a plurality of nodes, the removable flap permits the user to increase the number of nodes for a targeted area, or decrease the number of nodes thereby varying the intensity of the resultant massage effect. Additionally, if the massage assembly 22 includes nodes of one material density, such as a structural plastic, and the massage nodes 34 of the removable flap 30 include another material, such as an elastomeric material, the user can dampen the massage effect by employing the removable flap 30.

The invention contemplates any massage formation provided on the removable flap 30. Additionally, the invention contemplates any pattern of massage formations, such as massage nodes 34 on the removable flap 30. Further, the invention contemplates various interchangeable massage flaps 30 for providing varying massage effects. Such various massage effects may be provided by varying the pattern of the massage nodes 34 within the arrays 32. Additionally, variations may include the size or shape of the massage nodes 34 within the arrays 32. Other variations may include altering the materials of the massage nodes 34. For example, massage nodes 34 of varying durometers may be employed for imparting massage effects of varying impacts.

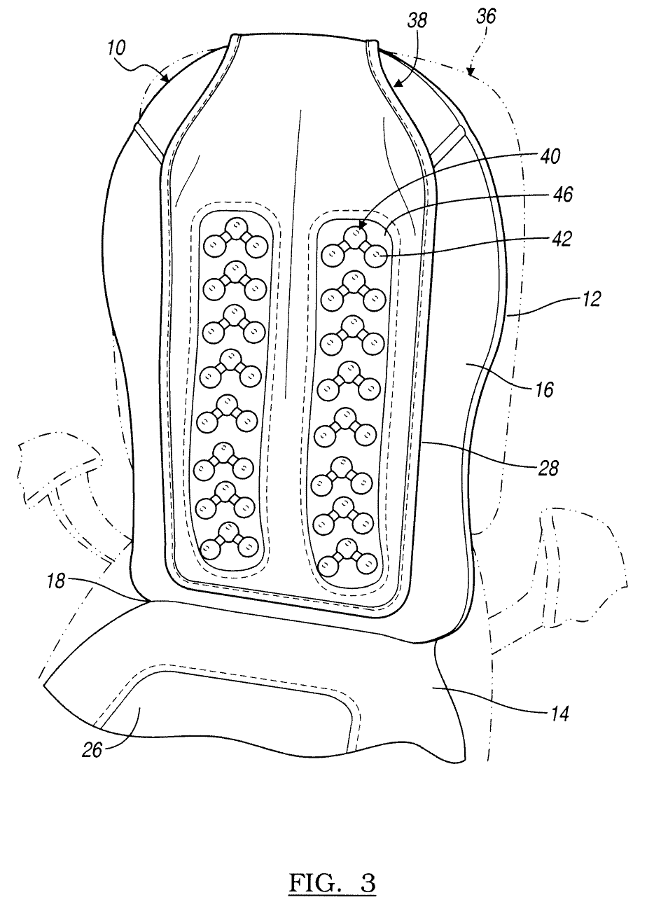

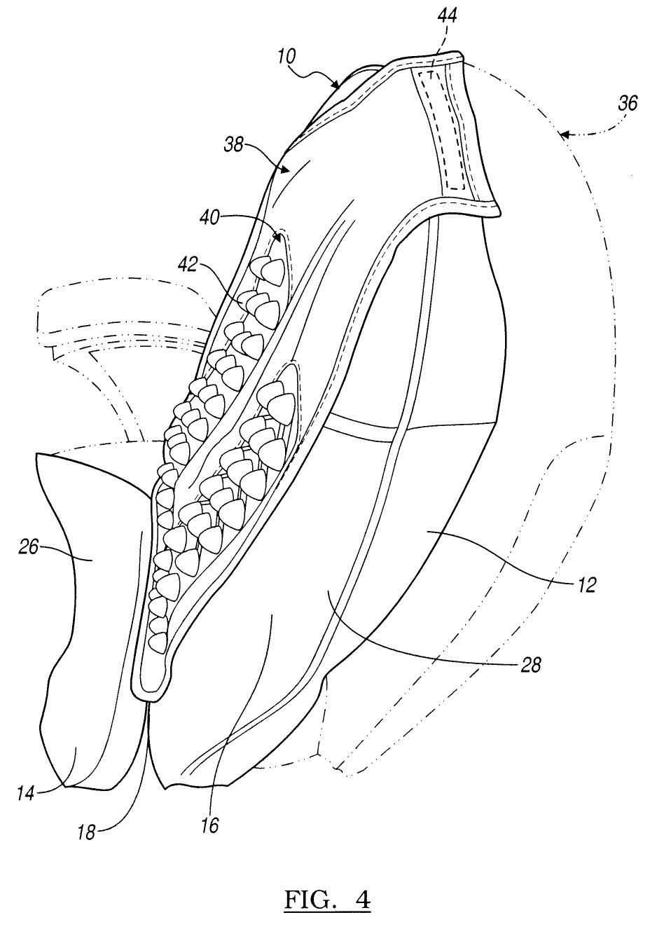

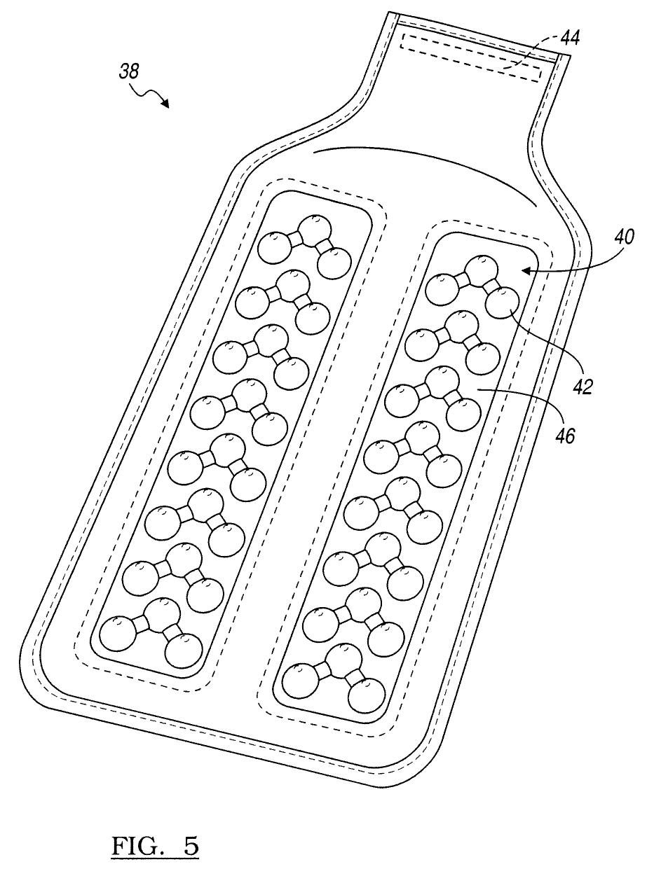

Referring now to FIGS. 3 and 4, the body massager 10 is illustrated seated upon a conventional chair, such as an office chair 36. A removable flap 38 is illustrated in accordance with another embodiment of the present invention. The removable flap 38 includes a pair of arrays 40 of massage nodes 42. The arrays 40 differ from those depicting in the prior embodiment by staggering a center column of each array 40 relative to the outboard and inboard column of nodes 42. Thus, by varying the pattern, the resultant massage effect is varied. A top region of the removable flap includes a hook and loop fastener region 44 mounted underneath for fastening the flap 38 to the body massager 10 by engaging the corresponding hook and loop fastener region.

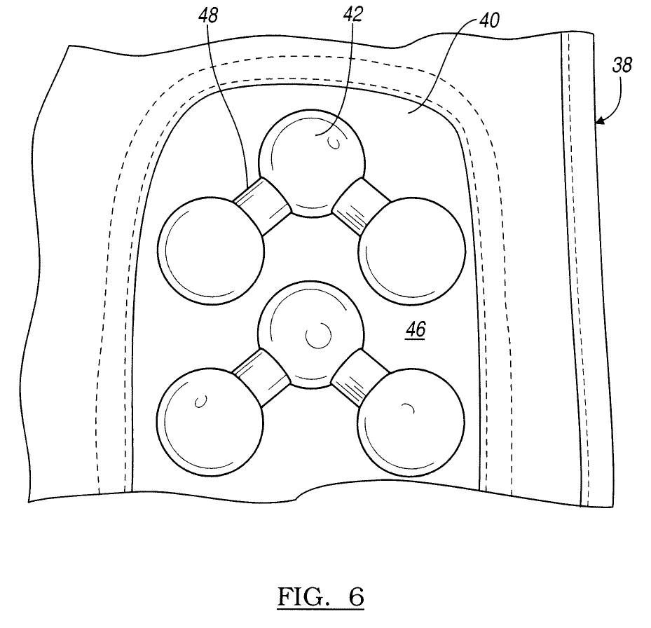

FIG. 5 illustrates the removable flap 38 removed from the body massager 10. FIG. 6 illustrates an enlarged view of a portion of one of the massage node arrays 40 of the removable flap 38. The massage node arrays 40 are provided upon a transparent panel 46 in at least one embodiment for permitting the user to view the underlying body massager 10 and massage assembly 22. The massage nodes 42 may be adhered directly to the panel 46, or alternatively may be molded directly to the panel 46. In at least one embodiment, the massage nodes 42 are each secured to the flap 38 independent of the other massage nodes 42.

Alternatively, adjacent massage nodes 42 may be provided with cross members 48 interconnecting adjacent massage nodes 42 as depicted in FIG. 6. The cross members 48 may be utilized for forming adjacent massage nodes 42 integrally in a forming operation, such as molding. The cross members 48 may be removed after the molding operation, or incorporated into the massage node array 40. The cross members 48 may be utilized for maintaining the orientation of the massage nodes 42 while fastening the massage nodes 42 to the panel 46. Alternatively, the cross members 48 may be utilized for conveying a massage effect that is imparted upon one massage node 42 to adjacent massage node 42.

The various removable flaps 30, 38 disclosed herein, can be utilized with a wide variety of massage assemblies for varying the resultant massage effect. The invention contemplates that the removable flaps 30, 38 can be employed for massagers having percussive massage assemblies, rolling massage assemblies, kneading massage assemblies, rotary kneading massage assemblies, vibratory massage assemblies, or the like. Additionally, the cover flaps 30, 38 may be employed for seat cushion type massagers such as the body massager 10 illustrated herein, mat massagers, pillow massagers, or the like. Additionally, the flaps 30, 36 may be employed with a massage assembly when a motorized massage operation is discontinued, for imparting a massage effect by the user resting a body part upon the massage node arrays 32 or 40. Additionally, the removable flaps 30, 38 may be employed without a massage assembly and may be fastened directly to a conventional chair for providing the massage effect when the user rests a body part against the removable flaps 30, 38.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A removable cover portion for a body massager comprising a sheet of material sized to be placed upon the body massager and adapted to be fastened to the body massager, the sheet of material having a reduced contact area for altering a resultant massage effect from the body massager by increasing pressure at each contact point.

2. The cover portion of claim 1 wherein the reduced contact area further comprises a plurality of massage nodes mounted to the sheet.

3. The cover portion of claim 2 wherein the plurality of massage nodes further comprises two arrays of massage nodes, each array spaced laterally from a center of the sheet of material.

4. The cover portion of claim 3 further comprising a plurality of cross members each interconnecting a pair of adjacent massage nodes.

5. The cover portion of claim 4 wherein the cross members distribute the massage effect from one of the pair of adjacent massage nodes to the other of the pair of adjacent massage nodes.

6. A set of interchangeable cover portions for a body massager, the set comprising:
a first cover portion according to claim 2; and
a second cover portion according to claim 2, wherein the second cover portion has a different number of massage nodes than the first cover portion to vary the resultant massage effect.

7. A set of interchangeable cover portions for a body massager, the set comprising:
a first cover portion according to claim 2; and
a second cover portion according to claim 2, wherein the massage nodes of the second cover portion have a different density than the massage nodes of the first cover portion to vary the resultant massage effect.

8. The set of cover portions of claim 7 wherein the massage nodes of the second cover portion are formed from a plastic material.

9. The set of cover portions of claim 7 wherein the massage nodes of the second cover portion are formed from an elastomeric material.

10. A set of interchangeable cover portions for a body massager, the set comprising:
a first cover portion according to claim 2; and
a second cover portion according to claim 2, wherein the second cover portion has a different pattern of massage nodes than the first cover portion to vary the resultant massage effect.

11. The set of cover portions of claim 10 wherein the second cover portion has at least three columns of incrementally spaced massage nodes.

12. The set of cover portions of claim 11 wherein the second cover portion has a center column of massage nodes that is offset from the other two columns of massage nodes.

13. The cover portion of claim 1 further comprising at least one transparent panel provided in the sheet of material for viewing the underlying massager.

14. The cover portion of claim 13 further comprising a plurality of massage nodes mounted to the at least one transparent panel.

15. A body massager comprising:
a motorized massage assembly; and
a removable cover portion according to claim 1.

16. The body massager of claim 15 wherein the body massager is further defined as a seat cushion massager.

17. A removable cover portion for a body massager comprising a sheet of material sized to be placed upon the body massager and adapted to be fastened to the body massager, the sheet of material having a reduced contact area for altering a resultant support effect from the body massager by increasing pressure at each contact point.

18. A method for manufacturing a removable cover portion for a body massager for altering a resultant massage effect from the body massager, the method comprising:
providing a sheet of material sized to be placed upon the body massager and adapted to be fastened to the body massager;
integrally forming a massage formation with at least two massage nodes and a cross member interconnecting the at least two massage nodes; and
assembling a plurality of massage formations to the sheet of material whereby the cross members maintain the orientation of the corresponding adjacent massage nodes during assembly of the massage nodes to the sheet of material.

19. The method of claim 18 further comprising adhering the plurality of massage formations to the sheet of material.

20. The method of claim 18 further comprising insert molding the plurality of massage formations to the sheet of material.
